(19) United States
(12) Patent Application Publication
(10) Pub. No.: US 2025/0289944 A1
(43) Pub. Date: Sep. 18, 2025

(54) COMPOSITION FOR PACKAGING FILM

(71) Applicant: Dow Global Technologies LLC, Midland, MI (US)

(72) Inventors: Michelle Tsui, Houston, TX (US); Jong-Young Lee, Sugar Land, TX (US); Scott B. Marks, Newark, DE (US); Hieu Truong McElroy, Manvel, TX (US)

(21) Appl. No.: 18/861,402

(22) PCT Filed: Jul. 25, 2023
(86) PCT No.: PCT/US2023/070980

§ 371 Date: Oct. 29, 2024

Related U.S. Application Data
(60) Provisional application No. 63/369,400, filed on Jul. 26, 2022.

(51) Int. Cl. C08L 23/0876; B32B 1/00; B32B 27/08; B32B 27/10; B32B 27/20; B32B 27/30; B32B 27/32; B65D 65/40; C08J 3/22; C08J 5/18; C08K 3/36; C08K 5/20

(52) U.S. Cl. CPC C08L 23/0876; B32B 1/00; B32B 27/08; B32B 27/10; B32B 27/20; B32B 27/308; B32B 27/32; B65D 65/40; C08J 3/226; C08J 5/18; C08K 3/36; C08K 5/20; B32B 2307/554; B32B 2307/5825; B32B 2307/744; B32B 2439/70; C08J 2323/08; C08J 2423/08; C08L 2203/16; C08L 2205/02; C08L 2310/00

(57) ABSTRACT

A composition for fabricating an abrasion resistant film including: (a) at least one ionomer of acid copolymer; (b) at least one anti-slip additive; (c) at least one anti-blocking additive; (d) at least one chill roll release additive; and (c) optionally, one or more additives different from components (a)-(d); a process for producing the above film composition; a monolayer abrasion resistant film or a multilayer abrasion resistant film, wherein at least one layer of the monolayer film or the multilayer film includes an abrasion resistant film layer fabricated from the above film composition; and a process of manufacturing the above monolayer film or multilayer film.

### FIELD

The present invention relates to a composition for fabricating packaging film; and more specifically, the present invention relates to a composition for fabricating an abrasion and scratch resistant film for a packaging container used in food packaging.

### BACKGROUND

Using recycled materials is thought to be better for the environment and decreases the waste of natural resources that are used for disposable products. Therefore, many industries desire to use recyclable materials in products and/or the packaging of products to provide for the recycling of disposable products and a reduction of natural resources. In the packaging industry, the current structure of some containers for various food contact packaging applications are generally made of a combination of various materials wherein some of the materials are recyclable and some of the materials are non-recyclable. Producing a final food packaging container with non-recycle materials makes it difficult and, in some cases impossible, to recycle the food packaging container once the container is disposed. For example, a package container (e.g., bottles, bags, sachets, pouches such as pillow pouches, or cans such as composite cans) for packaging a food product can include a multi-layered structure including several layers of different materials such as a combination of paper, gas and/or moisture barrier material, and polymer resin layers.

Typically, in the construction of a container for food packaging having a multi-layer film structure, the inner most film layer (i.e., the “film liner”) of the container is in contact with the food product and is required to fulfill many critical quality requirements such as, for example, (1) high abrasion and scratch resistance properties; (2) extended shelf-life of the food product packaged; and (3) excellent sealing performance.

Heretofore, film liners used in food contact applications have successfully been made from ionomer polymer resins based on a copolymer of ethylene and methacrylic acid, such as SURLYN™ available from The Dow Chemical Company. Such film liners generally have some good properties such as high abrasion resistance, scratch resistance, long shelf-life, increased sealing performance; and recyclability; and such film liners have had some success in providing packaging multilayer films for food packaging. In some instances, however, it is desirous for the packaging industry to downgauge the film liner of multilayer package container to save on the amount of materials used in the fabrication of the package container while maintaining the above-mentioned good properties. Unfortunately, it has been found that when the inner layer (film liner) made of previously known ionomer compositions are downgauged, the shelf-life of the food product in contact with the downgauged film liner is reduced significantly.

It would be desirous to provide an alternative ionomer composition which can be used for fabricating an abrasion and scratch resistant film such as a film liner for packaging applications, wherein the film liner, in addition to being recyclable, can be downgauged without compromising the abrasion, scratch, oil and seasoning resistance properties of the downgauged film liner and/or without compromising the shelf-life of the packaged food product.

### SUMMARY

One general embodiment of the present invention is directed to a polymer resin composition or formulation for use in producing an abrasion and scratch resistant film (herein abbreviated as “ARF”) for packaging applications. The present invention polymer resin composition includes a combination of an ionomer and several additives wherein the additives are used at unique levels such that an ARF fabricated from the resin composition containing such additives advantageously has a high level of abrasion resistance and scratch resistance in the presence of oil and seasoning. In addition, a fabricated container packaging product including an ARF layer of the present invention such as a film liner for the container wherein the film liner can advantageously be downgauged by 0% (no downgauging) up to 80% in one general embodiment without detrimentally affecting the shelf-life of the food product in contact with the ARF. Furthermore, the fabricated container packaging product of the present invention can be recyclable.

In one preferred embodiment of the present invention, the film composition includes, for example, the following:
(a) from 20 wt % to 100 wt % of at least one ionomer resin comprising an ethylene copolymerized with acid (such as (meth)acrylic acid groups; wherein the at least one ionomer resin contains selective ions of sodium, zinc, iron, magnesium; possesses improvements in abrasion resistance, scratch resistance, chemical resistance; and resistance to oil, salt, and seasoning; and in one general embodiment, has a selective neutralized acid level of >5%, a selective free acid level of >7%, and a selective total acid level of >13%;
(b) from 0.5 wt % to 5 wt % of at least one anti-slip additive in the form of a masterbatch material made from an ethylene (meth)acrylic acid copolymer; wherein the at least one anti-slip additive has the following property or properties: slow blooming long-chain, fatty acid amides or aliphatic amides;
(c) from 0.25 wt % to 3 wt % of at least one anti-blocking additive in the form of a masterbatch material made from an ethylene (meth)acrylic acid copolymer as the carrier resin; wherein the at least one anti-blocking additive has the following property or properties: being a non-migratory substance including, for example, a non-migratory organic compound or inorganic, synthetic mineral or natural mineral particles;
(d) from 0.1 wt % to 3 wt % of at least one chill roll release additive in the form of a masterbatch material made from an ethylene (meth)acrylic acid copolymer as the carrier resin; wherein the at least one chill roll release additive has the following property or properties: fast blooming long-chain, fatty acid amides and primary amides; and
(e) optionally, one or more other additives different from components (b)-(d).

In another embodiment, the present invention is directed to a monolayer or multilayer film made from the above film composition.

In still another embodiment, the present invention is directed to a fabricated container packaging product having a multi-layer packaging structure, including at least one inner ARF layer made from the above film composition.

In other embodiments, the present invention is directed to processes for preparing the above formulation, preparing the above ARF layer, and preparing the above multi-layer packaging structure.

### BRIEF DESCRIPTION OF THE DRAWINGS

FIG. 1 is a cross-sectional view of a can container of the present invention showing the different layers of the wall of the container.

FIG. 2 is a black and white image of the perspective front view of a film sheet of the prior art showing regions of the film sheet before the film sheet has been subjected to an abrasion process.

FIG. 3 is a black and white image of the perspective front view of a film sheet of the prior art showing abraded and scratched regions of the film sheet after the film sheet has been subjected to an abrasion process.

FIG. 4 is a black and white image of the perspective front view of a film sheet of the present invention showing regions of the film sheet before the film sheet has been subjected to an abrasion process.

FIG. 5 is a black and white image of the perspective front view of a film sheet of the present invention showing abraded and scratched regions of the film sheet after the film sheet has been subjected to an abrasion process.

FIG. 6 is a black and white image of the perspective front view of another film sheet of the prior art showing abraded and scratched regions of the film sheet after the film sheet has been subjected to an abrasion process.

FIG. 7 a black and white image of the perspective front view of another film sheet of the present invention showing abraded and scratched regions of the film sheet after the film sheet has been subjected to an abrasion process. The film sheet of FIG. 7 can be compared to the film sheet of FIG. 6.

### DETAILED DESCRIPTION

Reference will now be made in detail to embodiments of the ARF made from a film composition including an ionomer polymer resin based on a copolymer of ethylene and (meth)acrylic acid. The ARFs may be used in food product packaging applications; however, it is noted that this is merely an exemplary an illustrative implementation of the embodiments disclosed herein. The embodiments are applicable to other packaging technologies that desire incorporation of a film material that (1) has high abrasion and scratch resistance properties, (2) can be downgauged while maintaining its properties, (3) is recyclable, and (4) is resistance to oil, grease and seasoning when present in and about the food product being packaged.

The term “composition” refers to a mixture of materials that comprises the composition, as well as reaction products and decomposition products formed from the materials of the composition.

The term “recyclability” with reference to a packaging article including paper as the recyclable material herein refers to the property of the packaging article whereby the article is capable of being processed through a paper recycling and repulping process to recover the paper of the packaging article and convert the recovered paper back into pulp. For example, in one embodiment, a paper recycling and repulping process includes the steps of: (1) shredding the packaging article containing paper; (2) immersing the shredded article in an aqueous solution that breaks apart and separates the fiber into a pulp; (3) filtering to separate the pulp from any debris including plastic film; and (4) recovering the separated pulp and (5) converting the recovered pulp back into recycled paper products. As known to those skilled in the art, in one embodiment, one method to determine recyclability of paper is by determining the pulp yield, i.e., how much reusable pulp is collected during the repulping process.

As used herein, the term “polymer” refers to a polymeric compound prepared by polymerizing monomers, whether of the same or a different type. The generic term “polymer” thus embraces: (1) the term homopolymer (employed to refer to polymers prepared by polymerizing only one type of monomer, with the understanding that trace amounts of impurities can be incorporated into the polymer structure); and (2) the term copolymer or interpolymer (employed to refer to polymers prepared by polymerizing two or more different monomers, with the understanding that trace amounts of impurities can be incorporated into the polymer structure). Trace amounts of impurities (for example, catalyst residues) may be incorporated into and/or within the polymer. A polymer may be a single polymer or a polymer blend.

The term “interpolymer” refers to polymers prepared by polymerizing at least two different types of monomers. The generic term interpolymer thus includes copolymers and other polymers prepared by polymerizing more than two different monomers, such as terpolymers.

An “ionomer” is a copolymer of an ethylene and an ethylenically unsaturated monocarboxylic acid having the carboxylic acid groups partially neutralized by a metal ion, such as sodium or zinc. Useful ionomers herein include those in which sufficient metal ion is present in the ionomer to neutralize from 15% to 60% (neutralization percentage) of the acid groups in the ionomer. The carboxylic acid includes, for example, “(meth)acrylic acid”. “(Meth)acrylic acid” herein means acrylic acid and/or methacrylic acid. Useful ionomers (or the “partially neutralized ethylene acid copolymer”) include those having at least 50 wt % ethylene units in one embodiment, from 50 wt % to 90 wt % ethylene units in another embodiment, and from 80 wt % to 90 wt % ethylene units in still another embodiment. Useful ionomers also include those having from 1 wt % to 20 wt % acid units.

As used herein, the terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

As used throughout this specification, the abbreviations given below have the following meanings, unless the context clearly indicates otherwise: “=” means “equal to”; “<” means “less than”; “>” means “greater than”; “≤” means “less than or equal to”; “≥” means “greater than or equal to”; “I₂” means “melt index for 2.16 kilograms applied weight at 190 degrees Celsius”: g=gram(s); mg=milligram(s); pts=parts by weight; kg=kilogram(s); Kg/h=kilograms per hour; g/cc=gram(s) per cubic centimeter; kg/m³=kilogram(s) per cubic meter; g/mol=gram(s) per mole; L=liter(s); mL=milliliter(s); g/L=gram(s) per liter; Mw=mass molecular weight; Mn=number molecular weight; Mz=z-average molecular weight; m=meter(s); μm=micron(s): mm=millimeter(s); cm=centimeter(s); min=minute(s); s=second(s); mm/s²=millimeter(s) per second squared; mm/s=millimeter(s) per second; ms=millisecond(s); hr=hour(s); mm/min=millimeter(s) per minute; m/s=meter(s) per second;° C.=degree(s) Celsius; C/min=degree(s) Celsius per minute; mPa·s=millipascals-second(s); MPa=megapascal(s); kPa=kilopascal(s); Pa·s/m²=pascals-second(s) per meter squared; N=newton(s); cN=centinewton(s); rpm=revolution(s) per minute; mm²=millimeter(s) squared; g/10 min=gram(s) per 10 minutes; J=Joule(s); J/g=Joule(s) per gram; %=percent; eq %=equivalent percent; vol %=volume percent; and wt %=weight percent.

Unless stated otherwise, all percentages, parts, ratios, and like amounts, are defined by weight. For example, all percentages stated herein are weight percentages (wt %), unless otherwise indicated.

Temperatures are in degrees Celsius (° C.), and “ambient temperature” means between 20° C. and 25° C., unless specified otherwise.

In a broad embodiment, the present invention relates to a resin formulation or composition useful for preparing a food product packaging film comprising, for example, a combination, blend or mixture of: (a) at least one ionomer of acid copolymer; (b) at least one anti-slip additive (e.g., CONPOL™ 20S1); (c) at least one anti-blocking additive (e.g., CONPOL™ 13B); (d) at least one anti-blocking additive (e.g., CONPOL™ 5R); and (e) optionally, one or more additives different from components (b)-(d), if desired.

In some embodiments, the above resin composition is advantageously used to make a film product such as a monolayer film or a multilayer film. In one embodiment, the film product is incorporated into a multilayer structure (i.e., a structure comprising various different substrate layers) food product packaging container wherein the film product of the present invention is at least one of the substrate layers of the multilayer structure. The film product of the present invention can be a monolayer film or a multilayer film wherein the at least one monolayer film or the at least one layer of a multilayer film comprises the at least one of the substrate layers of the multilayer structure making up the food product packaging container. In one embodiment, the film product of the present invention making up one of the substrates of the food product packaging container is a film liner in direct contact with the food product packaged inside the food product packaging container.

Prior to making a film product from the above-described resin composition, the resin composition is first processed into pellets. For example, the components (a)-(d) and optionally (e) forming the blend formulation are melt blended (mixed by melting, e.g., via an extruder) to make the melt blend formulation. Then, the melt blend formulation is passed from an extruder (e.g., a twin-screw extruder) through a strand die into a pelletizer to form the pellets of the blend formulation. Once made, the pellets are then processed to make a film product that exhibits the desired abrasion and scratch resistant properties.

In some embodiments, the film resin composition includes, for example:
(a) from 20 wt % to 100 wt % of at least one ionomer resin comprising an ethylene copolymerized with acid groups, such as (meth)acrylic acid groups; and wherein the at least one ionomer resin has several advantages including a beneficial percent acid content, a selective ion type, and a lower limit of ion concentration;
(b) at least one anti-slip additive provided as a masterbatch material made of an ethylene (meth)acrylic acid copolymer and the anti-slip additive; wherein the anti-slip additive content in the masterbatch is from 5 wt % to 25 wt % based on the total concentration of the one or more various anti-slip additives used in the masterbatch, for example, in one embodiment the anti-slip additive can be a combination of CONPOL™ 5B10S1 and CONPOL™ S1 and the concentration of the anti-slip additive can be 10% in CONPOL™ 5B10S1 and 20% in CONPOL™ S1; and wherein the at least one anti-slip additive has the following properties: slow blooming long-chain, fatty acid amides or aliphatic amides;
(c) at least one anti-blocking additive provided as a masterbatch material made of an ethylene (meth)acrylic acid copolymer and the anti-blocking additive; wherein the anti-blocking additive content in the masterbatch is from 3 wt % to 25 wt % based on the total concentration of the one or more various anti-block additives used in the masterbatch, for example, in one embodiment the anti-blocking additive can be a combination of CONPOL™ 5B10S1 and CONPOL™ 20B, and the concentration of the anti-blocking additive can be 5% in CONPOL™ 5B10S1 and 20% in CONPOL™ 20B; and wherein the at least one anti-blocking additive has the property of being, for example, a non-migratory substance, including for example, non-migratory organic compounds or inorganic compounds, synthetic minerals or natural mineral particles;
(d) at least one chill roll release additive provided as a masterbatch material made of an ethylene (meth)acrylic acid copolymer and the chill roll release additive; wherein the chill roll release additive content in the masterbatch is from 3 wt % to 10 wt % based on the total concentration of the one or more various chill roll release additives used in the masterbatch, for example, in one embodiment, the chill roll release additive can be CONPOL™ 5R and the concentration of the chill roll release additive can be 5% in CONPOL™ 5R; and wherein the at least one chill roll release additive has the property of being a fast blooming long-chain, fatty acid amide and primary amide; and
(e) optionally, one or more other additives different from the additive components (b)-(d).

In one general embodiment of the present invention, the film resin composition useful for preparing a film includes, for example, at least one ionomer resin. Exemplary of the ionomer resin, component (a), useful for preparing the film composition of the present invention includes for example, one or more polyolefins having one or more acidic functional groups wherein the acidic functional groups have been neutralized with a metal ion. The one or more acidic functional groups can include, for example, carboxylic acid, maleic anhydride, fumaric acid, and the like; and mixtures thereof. The metal ion can include, for example, sodium, zinc, iron, magnesium, and the like; and mixtures thereof. Exemplary of one preferred embodiment of the ionomer resin includes an ethylene copolymerized with acid groups such as (meth)acrylic acid groups.

Exemplary of some commercial ionomer resin useful for preparing the film composition of the present invention includes for example: SURLYN™, resins (available from The Dow Chemical Company; Primacor™ IO (available from SK Global Chemical Co. Ltd. company); and mixtures thereof.

The ionomer resin, component (a), used in preparing the film composition, can be present in the composition in an amount of generally from 20 wt % to 100 wt % in one embodiment; from 30 wt % to 100 wt % in another embodiment; and from 50 wt % to 100 wt % in still another embodiment, based on the total amount of components in the film composition. Below the aforementioned general range of the ionomer resin, the abrasion and scratch resistance properties of the packaging film in the presence of oil/seasoning are insufficient to provide the required protection for packaging applications.

In one general embodiment of the present invention, the film composition useful for preparing the film liner includes, for example, at least one anti-slip additive, component (b), in the form of a masterbatch material made with an ethylene (meth)acrylic acid copolymer as the carrier resin.

The anti-slip additive, component (b), is available in pellet form and a plurality of pellets is blended with the ionomer resin, component (a), to modify the surface properties of the resulting film article made from the film resin composition. For example, the anti-slip additive blooms to the film surface overtime and can be used to modify the coefficient of friction (COF) of the surface of the film made from the film composition. In some embodiments, the anti-slip additive can also reduce inline blocking during film extrusion and off-line film blocking during film roll unwinding.

Exemplary of the anti-slip additive, component (b), useful for preparing the film composition of the present invention includes for example: slow blooming long-chain, fatty acid amides, aliphatic amides, and mixtures thereof. In a preferred embodiment, the anti-slip additive includes, for example: oleyl palmitamide, erucamide, and mixtures thereof.

Exemplary of some commercial anti-slip additives, component (b), useful for preparing the film composition of the present invention includes for example: CONPOL™ (available from The Dow Chemical Company); Ampacet 10090 (available from Ampacet Corp); Crodamide ER™ (available from CRODA); and mixtures thereof.

The anti-slip additive, component (b), used in preparing the film composition, can be present in the composition in an amount of generally >0.05 wt % in one embodiment; from >0.05 wt % to 6 wt % in another embodiment; from 0.1 wt % to 5 wt % in still another embodiment; from 0.1 wt % to 3 wt % in yet another embodiment; and from 0.88 wt % to 1.5 wt % in even still another embodiment, based on the total amount of components in the film composition.

Below the aforementioned general range of the anti-slip additive, the COF of the film becomes too high and, as a consequence, the high COF slows down package production output. Also, below the aforementioned general range of the anti-slip additive, the abrasion and scratch resistance properties of the packaging film in the presence of oil/seasoning may decrease and deleteriously affect the required protection for packaging applications. Above the aforementioned general range of the anti-slip additive, the anti-slip additive may plate-out, film winding problems may occur, and the sealing performance of the film may decrease.

In one general embodiment of the present invention, the film composition useful for preparing the film liner includes, for example, at least one anti-blocking additive, component (c), in the form of a masterbatch material made with an ethylene (meth)acrylic acid copolymer as the carrier resin.

The anti-blocking additive, component (c), is available in pellet form and a plurality of pellets is blended with the ionomer resin, component (a), to modify the surface properties of the resulting film article made from the film composition. For example, the anti-blocking additive can be used to modify the surface of the film made from the film composition to prevent bubble blocking, for example when the film is fabricated on a blown film line as the internal layer. The anti-blocking additive also helps reduce the energy required to unwind the film roll. And, the anti-blocking additive helps to reduce the COF of the film. All of the above-mentioned beneficial results of using the anti-blocking additive, help to increase the production output rate of the film.

Exemplary of the anti-blocking additive, component (c), useful for preparing the film composition of the present invention includes, for example, diatomaceous earth (silicon dioxide), talc (magnesium silicate), synthetic silica (silicon dioxide), calcium carbonate, alumina-silicate ceramic, clay (aluminum silicate), mica (aluminum potassium silicate), stearyl erucamide, zinc stearate, silicone, glycerol monostearate, ethylene bis-stearamide and mixtures thereof. In a preferred embodiment, the anti-blocking additive includes, for example, silicon dioxide, talc, and mixtures thereof.

Exemplary of some commercial anti-blocking additives, component (c), useful for preparing the film composition of the present invention includes for example: CONPOL™ 13B, CONPOL™ 20B, CONPOL™ 5B10S1, and CONPOL™ 20T (all which are available from The Dow Chemical Company); and Crodamide BR (available from CRODA); and Ampacet 10063 (available from Ampacet Corp; and mixtures thereof.

The anti-blocking additive, component (c), used in preparing the film composition, can be present in the composition in an amount of generally >0.05 wt % in one embodiment; from >0.05 wt % to 6 wt % in another embodiment; from >0.1 wt % to 5 wt % in still another embodiment; from >0.1 wt % to 3 wt % in yet another embodiment; and from >0.5 wt % to 1 wt % in even still another embodiment, based on the total amount of components in the film composition.

Below the aforementioned general range of the anti-blocking additive, the resultant film will be difficult to unwind by a line operator. Above the aforementioned general range of the anti-blocking additive, the haze property of the film will increase and the sealing performance of the film will decrease.

In one general embodiment of the present invention, the film composition useful for preparing the film liner includes, for example, at least one chill roll release additive, component (d), in the form of a masterbatch material made with an ethylene (meth)acrylic acid copolymer as the carrier resin.

The chill roll release additive, component (d), is available in pellet form and a plurality of pellets is blended with the ionomer resin, component (a), to modify the surface properties of the resulting film article made from the film composition. For example, the chill roll release additive tends to migrate to the surface of the film between the film and the chill roll; and thus, the chill roll release additive can be used to modify the surface of the film made from the film composition to prevent the film from sticking to the chill roll.

Exemplary of the chill roll release additive, component (d), useful for preparing the film composition of the present invention includes, for example, fast blooming long-chain, fatty acid amides and primary amides. In some embodiments, for example, the amides can be saturated or unsaturated; and can include from oleyls (18 carbon atoms) through erucyls (22 carbon atoms); and mixtures thereof. In a preferred embodiment, the chill roll release additive includes, for example, oleamide, behenamide, and mixtures thereof.

Exemplary of some commercial chill roll release additives, component (d), useful for preparing the film composition of the present invention includes for example: CONPOL™ (available from The Dow Chemical Company); Ampacet™ (available from Ampacet Corp company); Crodamide (available from CRODA); and mixtures thereof.

The chill roll release additive, component (d), used in preparing the film composition, can be present in the composition in an amount of generally >0.05 wt % in one embodiment; from 0.05 wt % to 6 wt % in another embodiment; from 0.05 wt % to 5 wt % in still another embodiment; from 0.1 wt % to 2 wt % in yet another embodiment; and from 0.15 wt % to 1 wt % in even still another embodiment, based on the total amount of components in the film composition.

Below the aforementioned general range of the chill roll release additive, the resultant film will stick to the chill roll to the point where the film can break and a line operator would need to stop and restart the line. Above the aforementioned general range of the chill roll release additive, any further improvement would be minimal.

In another embodiment, the film composition of the present invention can include a wide variety of other optional additives. The additives in combination with the composition of the present invention may be formulated to enable performance of specific functions while maintaining the excellent benefits/properties of the composition. For example, the following additives may be blended into the formulated resin composition to form the film composition of the present invention including: antioxidants; anti-fog agents; pigments; colorants; UV stabilizers; UV absorbers; processing aids; fillers; compatibilizers; other ionomer resins different from component (a); other anti-slip additives (migratory and non-migratory slip additives) different from component (b); other anti-blocking additives different from component (c); other chill roll release additives different from component (d); and the like; and mixtures thereof.

The optional additive, when used in the film composition, can be present in the film composition in an amount of <10 wt % in one general embodiment, <5 wt % in another embodiment, <3 wt % in still another embodiment, and <1 wt % in yet another embodiment. In other embodiments the optional additive may be added to the film composition in an amount generally in the range of from 0 wt % to <10 wt % in one embodiment; from 0.1 wt % to <10 wt % in another embodiment, from 0.1 wt % to <5 wt % in still another embodiment; from 0.1 wt % to <3 wt % in yet another embodiment, and from 0.1 wt % to <1 wt % in even still another embodiment based on the total amount of components in the film composition.

In one broad embodiment of the present invention, a process for making the film resin composition includes, for example, mixing or blending components (a), (b), (c), and (d) described above; and any desired optional component (e) as described above. Both a dry blend process and a melt blend process (compounding process) as known to those skilled in the art of mixing polymer resins can be used. For example, the dry blending process, in one general embodiment, comprises mixing all the polymer pellets together using either a tumble or ribbon blender or any equivalent dry blender. For example, the compounding (or melt blending) process, in one general embodiment, comprises melt mixing the components (a), (b), (c), (d), and optionally (e) at a temperature of from 80° C. to 285° C. in mixing equipment known to those skilled in the art such as a twin screw extruder, a single screw extruder, a continuous mixer or a batch mixer to form a homogeneous melt;

Some of the advantageous/beneficial properties exhibited by the film composition produced according to the aforementioned mixing or compounding processes, can include, for example: the film composition can be easily produced, that is, the different components (a), (b), (c), (d), and optionally (e) of the composition can be dispersed easily and more evenly (uniformly or homogeneously); and the processability of the composition is improved, that is, a food product packaging film can be readily fabricated from easily processing the composition.

As disclosed herein below, when ARFs are fabricated using the above composition, the films exhibit exceptionally improved properties such as one or more of the following: an increased resistance to abrasion and scratches in the presence of vegetable oils, salt, vinegar, spices, and other seasonings, while maintaining chemical resistance, sealant caulkability, low heat seal initiation temperature, and high hot tack strength to fulfill the other requirements of the target application.

It is hypothesized, but not to be limited thereby, that the reason for the improved properties of abrasion/scratch resistance in the presence of vegetable oils, fat or grease substances included in food, and seasoning is because the composition of the present invention has a proportional increase in the total acid content and the neutralization percent compared to known films. It has been shown that increased total acid content and neutralization percent lead to increased chemical or food product resistance, toughness, and stiffness.

In some embodiments, the present invention is directed to producing an ARF from the film composition and the pellets described above. The ARF is useful as an inner layer (or film liner) for incorporating into packaging containers used in food product packaging applications, where the ARF layer is in contact with the food product. The ARF layer of the present invention has a combination of good properties such as a high level of abrasion and scratch resistance in the presence of oil and seasoning; the ARF layer of the present invention can be downgauged by up to 80% in one general embodiment without detrimentally affecting the shelf-life of the food product in contact with the ARF layer; and the container packaging product with the ARF layer of the present invention can be recyclable.

In some embodiments, the film composition described above can be fabricated into a ARF member having an abrasion resistance rating value, Y, of >6.0 according to the following Equation (I):

$$Equation ( I )$$

$$Y = 7.16 - 1.45 ( \frac{A - 3 952.72}{472.23} ) + 4.05 ( \frac{B - 532 \; 5.63}{1257.50} ) + 0.8 \; 50 ( \frac{C - 161.66}{155.33} )$$

wherein Y is an abrasion resistance rating of >6.0; wherein A is an average tensile break stress in the cross direction of the film member; wherein B is an average tensile break stress in the machine direction of the film member; and wherein C is an average normalized Elmendorf tear in the cross direction of the film member.

Equation (I) can be used to help predict the abrasion resistance of an abraded film, quantified by Y based on key physical properties A, B, and C that can be measured through standard ASTM methods. To determine Equation (I), software was used to conduct Multiple Linear Regression where the inputs for the continuous response variable Y were determined through the experimental Abrasion Resistance Rating Method for each of the Comparative Examples and the Inventive Examples. The software used is a commercial software including JMP which is a computer program for statistical analysis developed by JMP, a subsidiary of SAS Institute. The Abrasion Resistance Rating Method is described in detail in the Test Methods section, and the measured values of Y are presented in Table V for each Example. The inputs for the categorical response variables A, B, and C were measured physical properties of the Comparative Examples and the Inventive Examples, which are also included in Table V. The coefficient of determination value, R² (which can range from 0 to 1), for Equation (I) based on Multiple Linear Regression is, for example, 0.975.

In some embodiments, the abrasion resistance rating value, Y, of the ARF member can be, for example, from ≥6 to 9 in one general embodiment, from ≥6 to 8 in another embodiment and from ≥6 to 7 in still another embodiment.

In one broad embodiment of the present invention, the film composition described above is used for making an ARF such as a film liner. The film composition as described above can be, for example, a resin formulation or composition comprising a combination, blend or mixture of: (a) at least one ionomer of acid copolymer; (b) at least one anti-slip additive such as CONPOL™ 20S1; (c) at least one anti-blocking additive such as CONPOL™ 13B; (d) at least one chill roll release additive such as CONPOL™ 5R; and (e) optionally, one or more additives different from components (a)-(d), if desired.

The monolayer ARF structure includes, for example, a film sheet of any desired length and width; and has a thickness of, for example, from 5 μm to 380 μm in one general embodiment; from 10 μm to 250 μm in another embodiment; and from 10 μm to 100 μm in still another embodiment.

In one broad embodiment of the present invention, a process for making the monolayer film includes, for example, using any conventional film forming process such as a cast film process, a blown film process, an extrusion coating process, and other processes and equipment well known to those skilled in the art of forming films.

Some of the advantageous/beneficial properties exhibited by the monolayer film produced according to the above-described process, can include, for example, an improved performance in: (1) tear strength in the cross direction (CD) of the film; (2) CD break stress in the CD of the film using the test method described in ASTM D882; (3) machine direction (MD) break stress in the MD of the film using the test method described in ASTM D882; and (4) static and kinetic COF between a sealant layer and a metal surface using the test method described in ASTM D1894. Furthermore, in general, increased total acid % and neutralization % exhibited by the film leads to improved physical properties. In addition, the film can advantageously exhibit excellent sealing performance such improved hot tack, reduced heat seal initiation temperature, and improved caulkability.

When the film composition of the present invention is fabricated into a monolayer film, the fabricated film of the present invention exhibits a tear strength property of ≥1 gf/mil (0.4 N/mm) in the CD of the film in one general embodiment; ≥5 gf/mil (1.9 N/mm) in another embodiment; ≥10 gf/mil (3.9 N/mm) in still another embodiment; and ≥15 gf/mil (5.8 N/mm) in yet another embodiment. In some embodiments, the fabricated film of the present invention exhibits a tear strength property in the CD of from 1 gf/mil (0.4 N/mm) to 200 gf/mil (77 N/mm) in one general embodiment; from 5 gf/mil (1.9 N/mm) to 150 gf/mil (58 N/mm) in another embodiment; from 10 gf/mil (3.9 N/mm) to 100 gf/mil (39 N/mm) in still another embodiment; and from 10 gf/mil (3.9 N/mm) to 75 gf/mil (29 N/mm) in yet another embodiment as measured by the test method described in ASTM D1922. Below the aforementioned general range, the abrasion resistance of the film will be reduced; and above the aforementioned general range the abrasion resistance will be increased.

The fabricated monolayer film also exhibits a CD break stress of ≤7,000 psi (48.3 MPa) in the CD of the film in one general embodiment; ≤5,000 psi (34.5 MPa) in another embodiment; and ≤4,000 psi (27.6 MPa) in still another embodiment. In some embodiments; the film exhibits a CD break stress of from 500 psi (3.4 MPa) to 7,000 psi (48.3 MPa) in one general embodiment; from 500 psi (3.4 MPa) to 5,000 psi (34.5 MPa) in another embodiment; and from 500 psi (3.4 MPa) to 4,000 psi (27.6 MPa) in still another embodiment, as measure by the test method described in ASTM D882. Below the aforementioned general range, the film will not be able to support tension during downstream processes such as lamination or package conversion processes. Above the aforementioned general range, the abrasion resistance is reduced.

And, the fabricated monolayer film exhibits a MD break stress of ≥1,000 psi (6.9 MPa) in the MD of the film in one general embodiment, ≥2,000 psi (13.8 MPa) in another embodiment, and ≥4,700 psi (32.4 MPa) in still another embodiment. In some embodiments, the film exhibits a MD break stress of from 1,000 psi (6.9 MPa) to 8,000 psi (55.2 MPa) in embodiment; from 2,000 psi (13.8 MPa) to 7,000 psi (48.3 MPa) in another embodiment; and from 4,700 psi (32.4 MPa) to 6,000 psi (41.4 MPa) in still another embodiment, as measure by the test method described in ASTM D882. Below the aforementioned general range, the abrasion resistance of the film will be reduced; and above the aforementioned general range the abrasion resistance will be increased.

Furthermore, the fabricated film exhibits a static and kinetic COF between sealant and metal of ≤1 in one general embodiment; ≤0.5 in another embodiment; and ≤0.35 in still another embodiment. In some embodiments, the film exhibits a static and kinetic COF between sealant and metal of from 0.05 to 1.0 in one general embodiment; from 0.10 to 0.5 in another embodiment; and from 0.10 to 0.35 in still another embodiment, as measure by the test method described in ASTM D1894. Below the aforementioned general range, the film will be difficult to control and reduce packaging efficiency, because the low COF will cause the film to slip uncontrollably when being pulled through packaging machinery. Above the aforementioned general range, the packaging efficiency will also be reduced because the high COF will cause the film to stick at different points along the packaging line.

In addition to a monolayer film structure described above, in some embodiments, the ARF can comprise two or more film layers combined together to form the ARF used for food product packaging applications. For example, the ARF can be made of two, three, five, seven, nine or more layers. In one embodiment, the ARF comprises a two-layer film structure including (1) an outer skin layer and (2) an inner ARF layer co-extruded with the outer skin layer. For example, the two-layer film structure can be designated as an A/B film structure, wherein the A layer is the outer skin layer, and the B layer is the inner ARF layer. The inner ARF layer B is in contact with a food product which is packaged in a packaging article such as a can or canister. The outer skin layer A can be made of the same material as the inner ARF layer B; or the two layers A and B can be made of different materials.

In another embodiment, the ARF may be a three-layer film structure including an outer skin layer, an adhesion-promoting tie layer, and an inner film liner layer. For example, the three-layer ARF can be designated as an A/B/C film structure, wherein the A layer is the outer most skin layer; the B layer is the tie layer; and the C layer is the is the inner most ARF layer. The tie-layer B is disposed in between the outer layer A and the ARF layer C. The outer layer A and tie layer B can be made of the same material as the ARF layer C or of different materials. The inner ARF layer C is in contact with a food product which is packaged in a package including the inner ARF layer C.

In other embodiments, the multi-layer ARF of the present invention can be made of any number of layers of more than three using processes and equipment readily apparent to one skilled in the art of film making, provided that at least one layer of the multi-layer film member is an ARF layer made from the film composition of the present invention. For example, the inner most layer (or film liner) of a package can be an ARF layer which is in contact with a food product that is packaged in the package. The ARF layer advantageously has the proper balance of properties such as abrasion/scratch resistance, downgaugeability, and recyclability.

For the above-described various multilayer film members, the other layers (i.e., the layers not counting the inner film liner layer of the present invention), can be formed of any material known in the art for use in multilayer films. Thus, for example, in one embodiment, the outer skin layer A of the above-described two-layer structure can be formed, for example, of a polyethylene (homopolymer or copolymer), and the polyethylene can be, for example, a VLDPE, LDPE, LLDPE, MDPE, HDPE and mixtures thereof, as well as other polyethylenes known in the art. In another embodiment, for example, the outer skin layer A can be formed of a polyethylene (homopolymer or copolymer), a non-polyethylene polymer, e.g., a polypropylene, or a blend of a polyethylene and a non-polyethylene polymer.

Exemplary of some of the commercial materials useful for the outer skin layer A of the present invention film can include, for example, DOWLEX™ 2045G, DOWLEX™ NG 5045P, DOWLEX™ 2645G, DOWEX™ 2049G, DOWLEX™ 2038.68G, DMDA-6200 NT 7, DMDA-6400 NT 7, DOWLEX GM 8070G, LDPE 611A, AGILITY™ 2000, AGILITY™ 1023, LDPE™ 150E, 310E (all available from The Dow Chemical Company); Enable™ 2703 and Enable™ 3505 (both available from ExxonMobil); Lutene™ BE0400 (available from LG Chem); and mixtures thereof.

The various resin polymer materials described above can have a variety of densities and melt index properties. For example, in one preferred embodiment, the outer skin layer A can be made of a LDPE resin wherein the resin has a density of from 0.915 g/cc to 0.928 g/cc in one general embodiment; and a melt index, I₂, of from 0.10 g/10 min to 30 g/10 min in one general embodiment.

The thickness of the outer skin layer A, when used in the present invention multilayer film, can be, for example, from 2 μm to 380 μm in one general embodiment; from 7 μm to 260 μm in another embodiment; and from 7 μm to 100 μm in still another embodiment.

In multilayer film structures, one or more of the layer B as an adhesion-promoting tie layer, can include for example methylene-acrylic acid copolymers such as a series of copolymers under the tradename NUCREL™, which is available from The Dow Chemical Company; ethylene-vinyl acetate copolymers, and mixtures thereof.

The thickness of the tie layer B, when used in the present invention multilayer film, can be, for example, 2 μm to 380 μm in one general embodiment; from 7 μm to 260 μm in another embodiment; and from 7 μm to 100 μm in still another embodiment.

The film composition for fabricating the ARF layer C of the present invention is described above with reference to the monolayer film structure, i.e., the ARF layer C can be made from a film resin formulation or composition comprising a combination, blend or mixture of: (a) at least one ionomer of acid copolymer; (b) at least one anti-slip additive such as CONPOL™ 20S1; (c) at least one anti-blocking additive such as CONPOL™ 13B; (d) at least one chill roll release additive such as CONPOL™ 5R; and (e) optionally, one or more additives different from components (a)-(d), if desired.

Once the ARF layer is made, the ARF layer is attached to the other layers by coextrusion or lamination well known to the skilled artisan in the art of film making.

The thickness of the ARF layer, when used in the present invention multilayer film is, for example, 2 μm to 380 μm in one general embodiment; from 7 μm to 260 μm in another embodiment; and from 7 μm to 100 μm in still another embodiment

The density of the ARF layer is generally from 0.900 g/cc to 0.980 g/cc in one embodiment, from 0.920 g/cc to 0.980 g/cc in another embodiment, and from 0.935 g/cc to 0.980 g/cc in still another embodiment.

The melt index of the ARF layer is generally from 0.5 g/10 min to 50 g/10 min in one embodiment, from 1 g/10 min to 30 g/10 min in another embodiment, and from 2 g/10 min to 15 g/10 min in still another embodiment.

In one broad embodiment of the present invention, a process for making the multilayer film includes, for example, using any conventional film forming process such as a cast film process, a blown film process, an extrusion coating process, and other processes and equipment well known to those skilled in the art of forming films.

As aforementioned above, some of the advantageous properties exhibited by ARF product fabricated from the film composition using the above process of the present invention can include, for example, (1) the ARF exhibits an advantageously high level of abrasion resistance and scratch resistance in the presence of oil and seasoning; (2) a fabricated container packaging product including the ARF of the present invention can be downgauged by up to 80%, without detrimentally affecting the shelf-life of the food product in contact with the ARF; and (3) the fabricated container packaging product including the ARF of the present invention can be fabricated such that the fabricated container packaging product can be recyclable.

In some embodiments, the fabricated container packaging product including the ARF of the present invention can be downgauged by up to 80% in one embodiment, up to 70% in another embodiment, up to 60% in still another embodiment, and up to 50% in yet another embodiment. In other embodiments, the fabricated container packaging product including the ARF of the present invention can be downgauged by 0% (no downgauging) up to 80% in one general embodiment, from 5% up to 70% in another embodiment, from 5% up to 60% in still another embodiment, and from 5% to 50% in yet another embodiment. In some embodiments, the fabricated container packaging product including the ARF of the present invention can be downgauged by 10% up to 80% in one embodiment, from 10% up to 70% in another embodiment, from 10% up to 60% in still another embodiment, and from 10% up to 50% in yet another embodiment. In other embodiments, the fabricated container packaging product including the ARF of the present invention can be downgauged by 20% up to 80% in one embodiment, from 20% up to 70% in another embodiment, from 20% up to 60% in still another embodiment, and from 20% up to 50% in yet another embodiment.

Not to be limited to the following theory, it is theorized that by balancing: (1) the increase in neutralization and free acid of the ionomer; (2) the proper ion selection for the neutralization and (3) the decrease in COF of the film, the proper fabricated container packaging product including the ARF of the present invention can be made with the proper beneficial properties required for the film to be suitable of use in packaging applications.

The overall ARF has several advantageous properties when the total film product has several layers with at least one layer being the ARF layer of the present invention. For example, the whole film made from multiple layers exhibits improved properties such as abrasion resistance, scratch resistance, and oil resistance. And based on the COF of the resultant film product, the film may provide high sealant performance as well as, excellent machinability.

The ARF of the present invention prepared as described above can be used, for example, in food product packaging applications. For example, a package container (e.g., bottles, bags, sachets, pouches such as pillow pouches, or cans such as composite cans) for packaging a food product can include a multi-layered structure including several layers of different materials such as a combination of paper, gas and/or moisture barrier material, and polymer resin layers wherein at least one of the layers comprising the resin layers is an ARF layer of the present invention.

As aforementioned, a container such as a rigid container for food packaging may have a multi-layer film structure, the inner most film layer (i.e., the “film liner”) of the container being the ARF layer. The ARF layer is usually in direct contact with the food product and is required to have high abrasion and scratch resistance properties sufficient to maintain a proper shelf-life of the food product packaged. Particularly, when the food product contains sharp edges that abrade and scratch the inside of the rigid container during handling and transportation. As an illustration, and not to be limited thereby, food products that can be packaged in a rigid container having an ARF layer as the film liner of the present invention include, for example, food products having rough and sharp edges that can cause the film liner to be abraded and scratched such as nuts, grain, trail mix, pretzels, and the like.

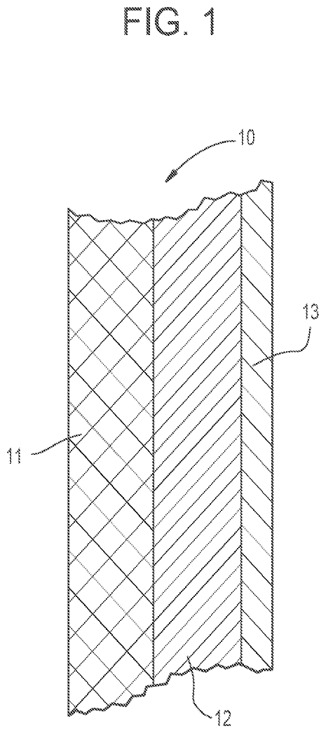

With reference to FIG. 1, there is shown a multi-layer structure including an ARF layer of the present invention. For example, the multi-layer structure can be a rigid container package generally indicated by reference numeral 10. In general, the rigid container package 10 is made from several layers of mixed materials, i.e., of various different substrates such as paper, plastic, metal and the like.

With reference to FIG. 1 again, there is shown the multi-substrate structure 10 of the present invention made from various substrates including, for example, a paper layer 11, an LDPE polymer or other polymer resin layer 12, and an ARF layer 13. The resulting multi-substrate structure 10 such as a rigid container with the ARF layer of the present invention is made of paper and plastic making the rigid container 10 advantageously recyclable. In some embodiments, other substrates (not shown), such as a gas and/or moisture barrier or a different plastic substrate, can be used as one of the layers of the rigid container (the multi-layer structure 10). In some embodiments of the present invention, the ARF layer 13 of the present invention exhibits improved abrasion, scratch, oil and seasoning resistance properties when used as a film liner in rigid containers 10 in which an abrasive food product, for example, is packaged. In the above example, the film liner of the rigid container exhibits improved abrasion, scratch, oil and seasoning resistance properties, while maintaining the required shelf-life of the food product even when the ARF layer 13 of the present invention is downgauged to form a thinner layer.

### Examples

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of compositions described herein. Unless otherwise, stated all parts and percentages are by weight on a total weight basis.

### ABBREVIATIONS AND DESIGNATIONS

Various terms, abbreviations, designations, and raw materials that are used in the Inventive Examples (Inv. Ex.) and the Comparative Examples (Comp. Ex.) are explained as follows:
“EMAA” stands for ethylene-methacrylic acid.
“EAA” stands for ethylene-acrylic acid.
“SBR” is a suffix used herein to indicate an addition of “slip(S)”, “anti-bock (B)”, and “chill roll release (R)” additives to a formulation.
“iBA” stands for iso-butyl-acrylate.

### Raw Materials

The ingredients/raw materials used in the Examples are described as follows:

SURLYN™ is a series of ionomer polymer resin products available from The Dow Chemical Company.

CONPOL™ is a series of additives employed in the above-described polymer resin products. The additives can include, for example, an anti-slip additive, an anti-blocking additive and a chill roll release additive; and the additives are available from The Dow Chemical Company.

### Resin Formulations for ARF

### General Procedure for Preparing ARF Formulations

The samples of ARF resin formulations (the film compositions) described in Table I were prepared by dry blending various polymer pellets of components (a). (b), (c), (d), and optionally (e) using a dry blender such as either a tumble blender or ribbon blender.

TABLE I
Formulations

| | Comp. | Inv. | Comp. | Comp. | Comp. | Comp. | Comp. | Comp. | Comp. | Comp. | Comp. | Comp. |
|---|---|---|---|---|---|---|---|---|---|---|---|---|
| | Ex.⁽⁶⁾A | Ex.⁽⁷⁾1 | Ex.⁽⁶⁾B | Ex.⁽⁶⁾C | Ex.⁽⁶⁾D | Ex.⁽⁶⁾E | Ex.⁽⁶⁾F | Ex.⁽⁶⁾G | Ex.⁽⁶⁾H | Ex.⁽⁶⁾I | Ex.⁽⁶⁾J | Ex.⁽⁶⁾K |
| Ingredient | | | | | | | | | | | | |
| IONOMER1, wt %: | 100 | | | | | | | | | | | |
| IONOMER2, wt %: | | | 88.6 | | | | | | | | | |
| IONOMER3, wt %: | | | | 88.6 | 44.3 | | | | | | | |
| IONOMER4, wt %: | | 85.5 | | | | 88.6 | | | | | | |
| IONOMER5, wt %: | | | | | | | 88.6 | | | | | |
| IONOMER6, wt %: | | | | | | | | 88.6 | | | | |
| IONOMER7, wt %: | | | | | | | | | 88.6 | | | |
| IONOMER8, wt %: | | | | | | | | | | 88.6 | 44.3 | |
| Terpolymer resin, | | | | | 44.3 | | | | | | 44.3 | 88.6 |
| wt %: | | | | | | | | | | | | |
| MASTERBATCH1⁽¹⁾, | | 4 | 4 | 4 | 4 | 4 | 4 | 4 | 4 | 4 | 4 | 4 |
| wt %: | | | | | | | | | | | | |
| MASTERBATCH2⁽²⁾, | | 3 | 3 | 3 | 3 | 3 | 3 | 3 | 3 | 3 | 3 | 3 |
| wt %: | | | | | | | | | | | | |
| MASTERBATCH3⁽³⁾, | | 7.5 | 4.4 | 4.4 | 4.4 | 4.4 | 4.4 | 4.4 | 4.4 | 4.4 | 4.4 | 4.4 |
| wt %: | | | | | | | | | | | | |
| Calculations | | | | | | | | | | | | |
| Total silicon dioxide | 5,000 to 5,250 | 5,200 | 5,200 | 5,200 | 5,200 | 5,200 | 5,200 | 5,200 | 5,200 | 5,200 | 5,200 | 5,200 |
| content, ppm: | | | | | | | | | | | | |
| Total AMIDE1⁽⁴⁾ | 1,429 | 1,500 | 1,500 | 1,500 | 1,500 | 1,500 | 1,500 | 1,500 | 1,500 | 1,500 | 1,500 | 1,500 |
| content, ppm: | | | | | | | | | | | | |
| Total AMIDE2⁽⁵⁾ | 8,571 | 15,000 | 8,800 | 8,800 | 8,800 | 8,800 | 8,800 | 8,800 | 8,800 | 8,800 | 8,800 | 8,800 |
| content, ppm: | | | | | | | | | | | | |

Notes for Table II:
⁽¹⁾“MASTERBATCH1” is an anti-block masterbatch with an anti-block additive and 13% silicon dioxide where the carrier resin is ethylene-methacrylic acid.
⁽²⁾“MASTERBATCH2” is a chill roll release masterbatch with 5% Amide1 where the carrier resin is ethylene-methacrylic acid.
⁽³⁾“MASTERBATCH3” is a slip masterbatch with 20% Amide2 where the carrier resin is ethylene-methacrylic acid.

### Films

### General Procedure for Preparing ARFs

After preparation of the samples of resin formulations (the film compositions) described in Table I, the formulations described in Table I were used to fabricate the various ARFs samples described in Table II. The film compositions were fabricated into ARF specimens in accordance with the following general procedure:

The ARF samples used in the Examples were cast films and a cast film process was used to fabricate the ARFs. Each of the ARF samples was of a mono-layer film structure. Each of the sample films had a total thickness of 50.8 μm.

The film samples were cast using a lab-scale, cast film line manufactured by COLLIN and equipped with a single 30 mm extruder. The fabrication parameters/conditions for the films were as follows:
(1) Gauge=2 mil (50.8 μm)
(2) Die Gap=20 mils (0.508 mm)
(3) Die Size=10 inches (250 mm)
(4) Air Gap=0.75 inches (19.05 mm)
(4) Screw speed=42 rpm
(5) Melt Pressure=35 MPa
(6) Output=5 kg/hr
(7) Line speed=0.112 m/s
(8) Draw-down Ratio=10:1
(9) Chill Roll Temperature=18° C.
(10) Film width after slitting inline=9 inches (228.6 mm)
(11) Melt Temperature=203° C.
(12) Extruder Temperature Profile for the various zones was as described in the following table:

| Zone | Setpoint | Actual Value |
|---|---|---|
| No. | (° C.) | (° C.) |
| 1 | 25 | 17 |
| 2 | 135 | 135 |
| 3 | 190 | 166 |
| 4 | 220 | 190 |
| 5 | 210 | 220 |
| 6 | 210 | 210 |
| 7 | 210 | 210 |
| 8 | 210 | 210 |
| 9 | 210 | 210 |
| 10 | 210 | 210 |

### Test Methods

### Average Break Stress in Cross Direction and Machine Direction

Generally, the average break stress test is conducted according to the procedure described in ASTM D882. The tensile force versus displacement curve, with the machine direction or cross direction of the film parallel to the direction of displacement, is measured while the film is pulled under uniaxial tension at a strain rate of 20 inches/min (8.47 mm/s). The stress versus strain curve is calculated from the measured force versus displacement curve and the break stress is taken as the stress at the point that the film fails (breaks). More specifically, the following method is used to determine the tensile properties of a thin plastic sheeting in accordance with the procedure described in ASTM D882.

Tensile tests are used to measure the properties of a film when tested under uniaxial extension. The film to be tested is conditioned for at least 40 hr after film production at 23° C. (+/−2° C.) and 50% RH (+/−10%) as per ASTM standards. Standard testing conditions are 23° C. (+/−2° C.) and 50% RH (+/−10%) as per the procedure described in ASTM D882.

Tensile test strips are cut from a sheet in (if applicable) the machine direction (MD) and the cross direction (CD). The cut strips are 1 inch (25.4 mm) wide by approximately 8 inches (203.2 mm) long. For standard tensile tests the test strip samples are loaded onto a tensile testing frame using line grip jaws (flat rubber on one side of the jaw and a line grip on the other side) set at a gauge length (line grip to line grip distance) of 2 inches (50.8 mm). The test samples are then strained at a crosshead speed of 20 inches/min (8.47 mm/s). From the resulting load-displacement curve the yield strength and yield strain, tensile strength and tensile strength at break, strain at break and energy to break can be determined. Strain is calculated using the crosshead extension divided by the original gauge length (2 inches) (50.8 mm). The stress is reported as the engineering or nominal stress and is the load divided by the original cross-sectional area.

### Average Normalized Elmendorf Tear Strength in Cross Direction

The force in grams required to propagate tearing across a film specimen is measured using a modified Pro-Tear Electronic Elmendorf Tear tester. Acting by gravity, the pendulum swings through an arc, tearing the specimen from a precut slit. The tear is propagated in the cross direction.

The Elmendorf Tear test determines of the average force to propagate tearing through a specified length of plastic film or nonrigid sheeting after the tear has been started, using an Elmendorf-type tearing tester.

The film is conditioned for at least 40 hr after film production at 23° C. (+/−2° C.) and 50% R.H (+/−10%) as per ASTM standards. Standard testing conditions are 23° C. (+/−2° C.) and 50% R.H (+/−10%) as per ASTM standards.

The force in grams required to propagate tearing across a film or sheeting specimen is measured using a precisely calibrated pendulum device. Acting by gravity, the pendulum swings through an arc, tearing the specimen from a precut slit. The specimen is held on one side by the pendulum and on the other side by a stationary member. The loss in energy by the pendulum is indicated by a pointer or by an electronic scale. The scale indication is a function of the force required to tear the specimen. The sample used is the ‘constant radius geometry’ as specified in D1922. Testing is typically carried out on samples that have been cut from both the MD and CD directions. Prior to testing, the sample thickness is measured at the center of the sample. A total of 15 specimens per direction (MD and CD) are tested and an average tear strength is reported. Samples that tear at an angle >60° from the vertical are described as “oblique” tears-such tears should be noted, though the strength values are included in the average strength calculation.

### Coefficient of Static (Dynamic) Friction (Sealant-to-Metal)

Generally, the coefficient of static and dynamic friction test is based on procedure described in ASTM D1894. The data is generated using a tensile frame with a COF attachment. A plastic film is secured to a flat surface and placed in contact with a flat, weighted, metal surface. The metal piece is displaced at a constant speed across the surface of the plastic film and the force required to displace the metal piece is used to calculate the coefficient of static and dynamic friction. Data reported is the average static and kinetic energy. Testing is conducted at 23° C. only. More specifically, the following method is used to determine static and kinetic coefficients of friction of a plastic film and sheeting in accordance with the procedure described in ASTM 1894.

The test described in ASTM D1894 is used to measure the coefficients of static and kinetic friction of plastic film/sheet. The coefficient of friction (COF) can be tested for different surface pairings: film to film (inside-inside, outside-outside or inside-outside) or film to metal (inside-metal or outside-metal).

The film sample to be tested is conditioned for at least 40 hr in an environment of 23° C. (+/−2° C.) and 50% RH (+/−10%) as per ASTM standards. Standard testing conditions are 23° C. (+/−2° C.) and 50% RH (+/−10%) as per ASTM standards.

Testing is carried out using an INSTRON 5564 Universal Testing Machine. A specimen of a film sample is cut to 3 inches×6 inches. (76.2 mm×152.4 mm) A B-type sled is used, which is a 2.5 inches×2.5 inches (63.5 mm×63.5 mm) square and weighs 195 g. The sample is wrapped snugly around the sled with the machine direction (MD) aligned parallel to the direction of movement. This is aided by the use of double-sided tapes pre-attached onto the top face of the sled. It is ensured that there are no wrinkles on the film surface to be tested. A COF measurement fixture which consists of a rigid plate with a low-friction pulley is attached to the fixed base of the equipment. A metal plate is then placed on top of the aforementioned rigid plate and is used subsequently as the plane on which the sled is to be driven. The crosshead is then driven at a speed of 6 inches/min (2.54 mm/s) for a distance of 3 inches (76.2 mm). The force at which the sample starts to move (initial peak in the load-displacement data) is the static force (F_{S}). The average load calculated between ½ inch (12.7 mm) and 3 inches (76.2 mm) of movement is the kinetic force (F_{K}). The static COF, μ_{S}, is the ratio of the static force (F_{S}) to the normal force (=weight of the sled, W). Similarly, the kinetic COF, μ_{K}, is the ratio of the kinetic force (F_{K}) to the normal force. Five specimens from the same film roll (sample) are tested. Each specimen is tested once. After each of the five specimens are tested, the average value of the test results is reported.

### Total Acid Level

The total acid level is the initial wt % of the acid functional group of ethylene acid incorporated into the copolymer.

### % Neutralized Acid

The ionomer is produced by adding salt into the ethylene acid copolymer during the compounding process. The neutralization percentage of the ionomer is determined by the ratio of mole percentage of the added salt to the mole percentage of the acid function group of ethylene acid copolymer. Wt % of the neutralized acid of the ionomer is determined by the product of neutralization percentage and the initial wt % of the acid function group of ethylene acid copolymer.

### Free Acid Level

Wt % of the free acid is obtained by the difference between the initial wt % of the acid function group of ethylene acid copolymer and the wt % of the neutralized acid.

### Average Abrasion Resistance Rating in Presence of Oil and Seasoning

For the purpose of rating the abrasion resistance for an ARF, a monolayer film sample of an ARF is subjected to an abrasion procedure using a shaker table process. Monolayer film samples having a thickness of 2-mil (0.0508 mm) are produced using a cast film process. To determine the average abrasion resistance rating for each monolayer film sample, each monolayer film sample is first cut into 210 mm×297 mm sheets where the MD direction of the cast film is parallel to the side that is 297 mm long. Three film specimens are cut from each sample film roll. A 5.5 oz (155.9 g) cylindrical can with a lid containing an abrasive food product which is also includes seasoning and oil on the surface of the food product is used. The cylindrical can is emptied of its abrasive food contents and cleaned. Each sheet sample is rolled into a cylinder and inserted into the emptied, cleaned, cylindrical can such that the film lined the inside of the can. The abrasive, seasoned, oily food product is then reinserted into the can carefully to prevent breakage of the food product. The cylindrical can lid is secured back on top of the cylindrical can. The cylindrical can with the abrasive food product is placed on a shaker table and shaken vertically at ambient temperature at 5 Hz frequency and 0.7-inch (17.78-mm) displacement for 24 hr. Following the shaker table process, the film is removed from the cylindrical can, cleaned, and photographed.

Images of each monolayer film samples are taken prior to and after the film samples are processed through the aforementioned abrasion procedure. The assembly for obtaining an image of the film samples (to image the films to reveal the abraded and scratched regions of the films), includes an optical camera and circular polarized lens in combination with a white backing light for the film and linear polarized film to enhance contrast of the abraded and scratched regions of the film; and to reduce glare.

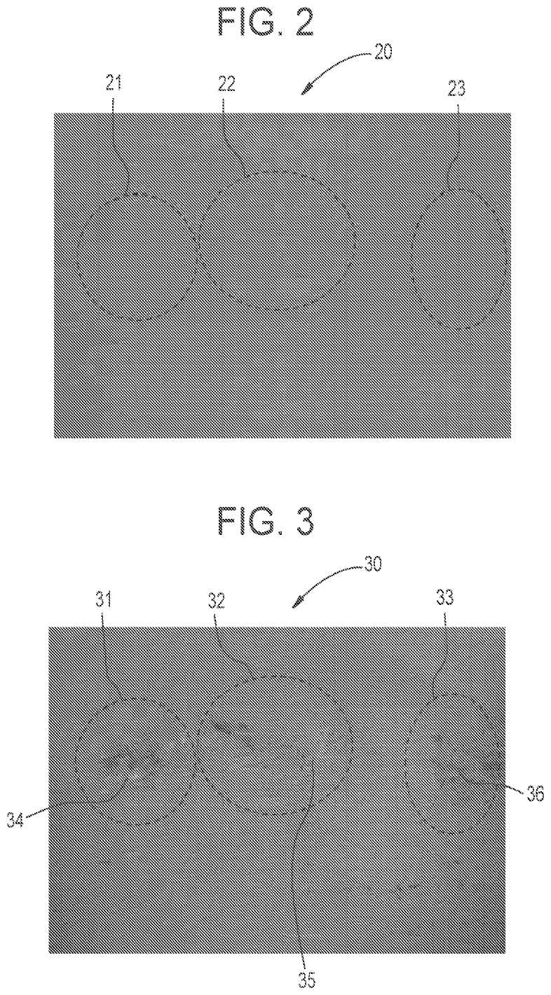

With reference to FIG. 2, there is shown a black and white image of a single (monolayer) film sheet of the prior art, generally indicated by reference numeral 20. The film sheet 20 is made using a known ionomer, for example, a copolymer of ethylene and methacrylic acid, such as SURLYN™ available from The Dow Chemical Company. The image of film sheet 20 of FIG. 2 is the film sheet before the film sheet is subjected to an abrasion process. In FIG. 2, there is shown three regions (areas or sections) of the film sheet generally indicated by dotted line circles 21, 22 and 23 of the film sheet 20. In FIG. 2, the film sheet 20 does not contain any abrasions in the regions 21, 22 and 23. After the film sheet 20 has been subjected to the abrasion process, a post-abrasion film sheet is formed with various abrasions and scratches present on the surface of the film sheet as shown in FIG. 3.

With reference to FIG. 3, there is shown a black and white image of a single (monolayer) film sheet of the prior art, generally indicated by reference numeral 30, after subjecting the film sheet (from FIG. 2) to an abrasion process. With reference to FIG. 3 again, there is shown the post-abrasion film sheet 30 with several abrasions and/or scratches located generally in the abraded and scratched regions which are generally indicated by dotted line circles 31, 32, and 33 of the film sheet 30. The abrasions and/or scratches on the film sheet 30 shown in FIG. 3 can be indicated by black or white areas such as those indicated by reference numerals 34, 35 and 36 located in regions 31, 32 and 33, respectively.

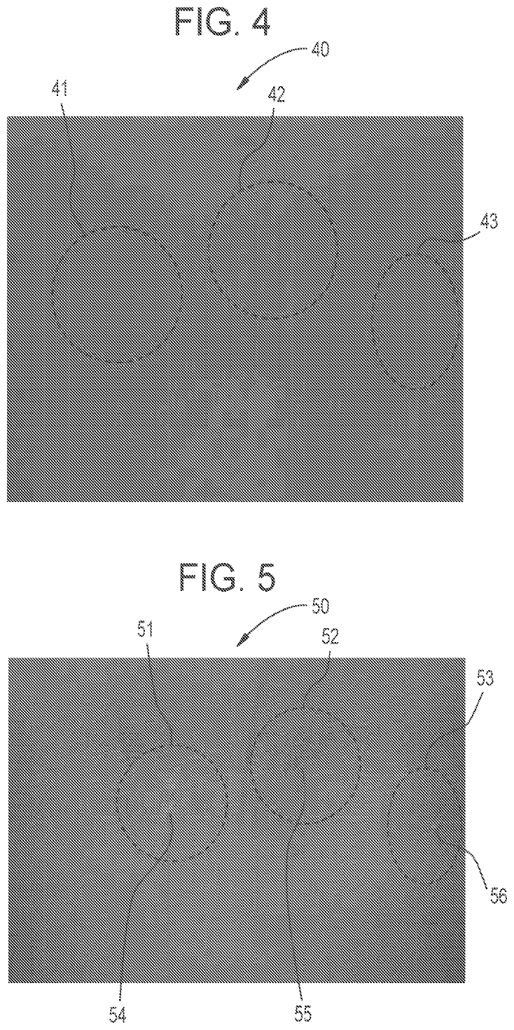

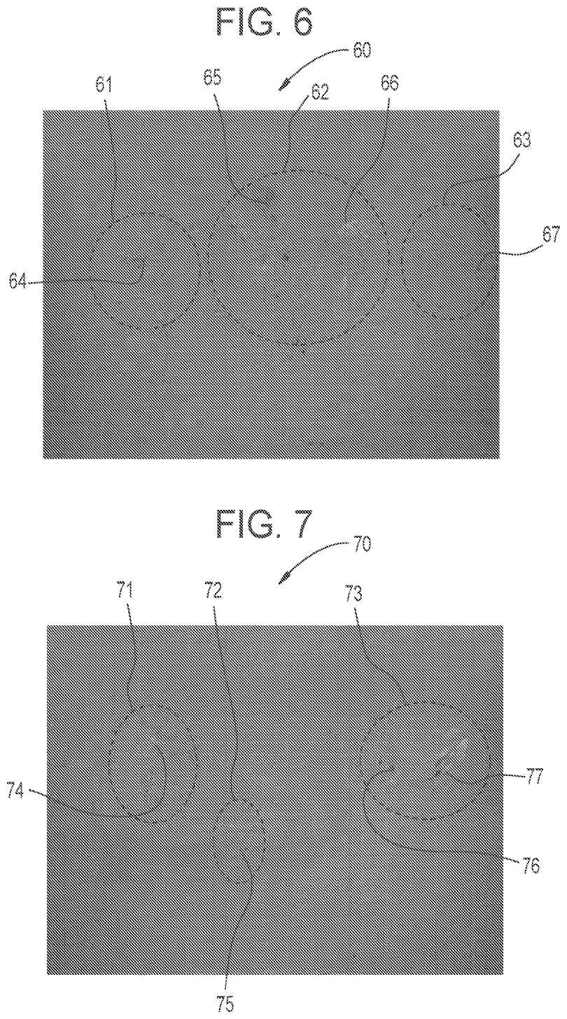

With reference to FIG. 4, there is shown a black and white image of a single (monolayer) film sheet of the present invention, generally indicated by reference numeral 40, made using the composition including the ionomer(s) of the present invention. The image of film sheet 40 of FIG. 4 is the film sheet before the film sheet is subjected to an abrasion process. In FIG. 4, there is shown three regions generally indicated by dotted line circles 41, 42 and 43 of the film sheet 40. In FIG. 4, the film sheet 40 does not contain any abrasions in the regions 41 and 42 of film sheet 40. After the film sheet 40 has been subjected to the abrasion process, a post-abrasion film sheet is formed with various abrasions and scratches present on the surface of the film sheet as shown in FIG. 6.

With reference to FIG. 5, there is shown a black and white image of a single (monolayer) film sheet of the present invention, generally indicated by reference numeral 50, after subjecting the film sheet (from FIG. 4) to an abrasion process. With reference to FIG. 5 again, there is shown the post-abrasion film sheet 50 with abrasions and/or scratches. The abrasions and/or scratches in FIG. 5 are located generally in the abraded and scratched regions which are generally indicated by dotted line circles 51, 52, and 53 of the film sheet 50. The abrasions and/or scratches on the film sheet 50 shown in FIG. 5 can be indicated by black or white areas such as those indicated by reference numerals 54, 55 and 56 located in regions 51, 52 and 53, respectively. The post-abrasion film sheet 50 shown in FIG. 5 has fewer abrasions and/or scratches compared to the post-abrasion film sheet 30 shown in FIG. 3.

The images shown in FIGS. 2-5 are prepared to determine the amount of abrasion/scratching that has occurred on the surface of the present invention film sheet 5 compared to the conventional film after the films have been subjected to an abrasion process. The abraded and scratched regions of the film sheets are also used for the purpose of rating the abrasion resistance of the films.

### Abrasion Resistance Rating Method

A rating system to determine the abrasion resistance rating, Y, for each film is used to semi-quantitatively compare the films to each other based on the appearance of the abraded and scratched areas on each film. The following system utilizing Equation (II) is used for the abrasion resistance rating, Y, where:

$$Y = {m}_{1} \times {A}_{1} + {m}_{2} \times {A}_{2} + {m}_{3} \times {A}_{3} + {m}_{4} \times {A}_{4} + {m}_{5} \times {A}_{5} ; \qquad Equation ( II )$$

where in Equation (II) mₙ is a multiplier factor to describe severity of abrasion for n=1, 2, 3, 4, or 5; and Aₙ is a rating factor corresponding to total % Abraded Areas with severity, mₙ. Tables II and III describe the factors Aₙ and mₙ, respectively, used in the above rating system and Equation (II). To aid in determining mₙ and Aₙ, a grid of 1 cm×1 cm squares was overlayed onto each film image and the squares that overlapped with any abraded area was outlined to indicate the presence of abrasion. The area within each outlined square was assigned a value mₙ based on the severity of abrasion. Guidelines used for this evaluation are specified in Table III. The total area of outlined squares corresponding to each mₙ was summed and divided by the total area of the image to determine the value of Aₙ according to Table II.

TABLE II
Abraded Areas

| Abraded | | | | | | | | |
|---|---|---|---|---|---|---|---|---|
| Areas | | | | | | 5 to | | |
| (%): | >80 | 50 to 80 | 35 to 50 | 25 to 35 | 15 to 25 | 15 | <5 | <1 |
| Rating | 1 | 3 | 5 | 6 | 7 | 8 | 9 | 10 |
| Factor | | | | | | | | |
| “A”: | | | | | | | | |

TABLE III
Factor “m”

| | | | | | |
|---|---|---|---|---|---|
| Severity of | Very Low | Low | High | Medium | Very High |
| Abraded | | | | | |
| Areas: | | | | | |
| Multiplier | m₁ = 0.95 | m₂ = 0.75 | m₃ = 0.55 | m₄ = 0.35 | m₅ = 0.15 |
| Factor “mₙ”: | | | | | |
| Qualitative | Abrasion is | Abrasion is | Abrasion is | Abrasion is | A hole is |
| Description of | visible by | easily visible | visible by the | visible by | clearly |
| Ratings: | contrast optical | by the naked | naked eye | the naked | present in the |
| | image but hard | eye but is | and appears | eye and | film and |
| | to see by the | light | cloudy but | appears | visible with |
| | naked eye | abrasion | not white | white | the naked |
| | | | | | eye |

### Results of Testing

The results of the properties of each of the film compositions that were tested are described in Table IV.

TABLE IV
Properties of the Film Composition

| Ex. No. of | % Neutralized | Free Acid | Total Acid |
|---|---|---|---|
| Formulation | Acid | Level | Level |
| Comp. Ex. A | 4.05 | 10.95 | 15 |
| Comp. Ex. B | 7.60 | 11.40 | 19 |
| Comp. Ex. C | 8.55 | 6.45 | 15 |
| Comp. Ex. D | NC* | NC* | NC* |
| Inv. Ex. 1 | 8.55 | 10.45 | 19 |
| Comp. Ex. E | 1.50 | 8.50 | NC** |
| Comp. Ex. F | 6.84 | 12.16 | 19 |
| Comp. Ex. G | 7.22 | 11.78 | 19 |
| Comp. Ex. H | 9.15 | 5.85 | 15 |
| Comp. Ex. I | NC*** | NC*** | NC*** |
| Comp. Ex. J | — | — | 10% acid; |
| | | | 10% iBA⁽¹⁾ |

Notes for Table IV:
*“NC” stands for “not calculated” since this composition is a blend of a terpolymer resin and IONOMER3.
**“NC” stands for “not calculated” since the base resin is a terpolymer resin that contains 10% total acid and 10% iBA.
***“NC” stands for “not calculated” since this composition is blend of a terpolymer resin and IONOMER8.
⁽¹⁾“iBA” stands for “iso-butyl-acrylate”. This composition is not an ionomer.

The results of the properties and performance of each of the ARFs that were tested are described in Table V.

TABLE V
Property and Performance of Films

| | | | | | Average | | | Average |
|---|---|---|---|---|---|---|---|---|
| | | | | | Normalized | Coefficient | | Abrasion |
| | | | Average | Average | Elmendorf | of Static | | Resistance |
| | Ex. No. of | | Break | Break | Tear | (Dynamic) | | Rating in |
| Ex. | Formulation | Brief | Stress in | Stress in | Strength in | Friction | | Presence |
| No. of | Used to | Description of | Cross | Machine | Cross | (Sealant- | Cation | of Oil and |
| ARF | Make ARF | ARF Materials | Direction | Direction | Direction | to-Metal) | Type | Seasoning |
| Comp. | Comp. Ex. | IONOMER1 | 4,135 | 5,377 | 26.597 | 0.295 | Sodium | 5.86 |
| Ex. L | A | | | | | (0.190) | | |
| Comp. | Comp. Ex. | IONOMER2 + | 3,871 | 4,482 | 44.795 | 0.179 | Sodium | 4.22 |
| Ex. M | B | SBR⁽¹⁾ | | | | (0.171) | | |
| Comp. | Comp. Ex. | IONOMER3 + | 3,619 | 4,068 | 17.615 | 0.266 | Sodium | 3.45 |
| Ex. N | C | SBR | | | | (0.19) | | |
| Comp. | Comp. Ex. | 50:50 | 4,052 | 5,084 | 44.795 | 0.320 | Sodium | 5.13 |
| Ex. O | D | Terpolymer | | | | (0.217) | | |
| | | resin:IONOMER3 + | | | | | | |
| | | SBR additives | | | | | | |
| | | (dry blend) | | | | | | |
| Inv. | Inv. Ex. 1 | IONOMER4 | 3,349 | 4,769 | 23.074 | 0.312 | Sodium | 6.47 |
| Ex. 2 | | | | | | (0.209) | | |
| Comp. | Comp. Ex. | IONOMER5 + | 3,480 | 4,562 | 174.725 | 0.380 | Zinc | 3.72 |
| Ex. P | E | SBR | | | | (0.297) | | |
| Comp. | Comp. Ex. | IONOMER6 + | 4,425 | 5,442 | 6.326 | 0.135 | Zinc | 5.83 |
| Ex. Q | F | SBR | | | | (0.165) | | |
| Comp. | Comp. Ex. | IONOMER7 + | 3,806 | 4,621 | 41.232 | 0.070 | Zinc | 3.68 |
| Ex. R | G | SBR | | | | (0.165) | | |
| Comp. | Comp. Ex. | IONOMER8 + | 3,858 | 6,583 | 15.434 | 0.088 | Zinc | 5.45 |
| Ex. S | H | SBR | | | | (0.127) | | |
| Comp. | Comp. Ex. I | 50:50 | 3,858 | 4,462 | 64.801 | 0.189 | Zinc | 4.62 |
| Ex. T | | Terpolymer | | | | (0.241) | | |
| | | resin:IONOMER8 + | | | | | | |
| | | SBR additives | | | | | | |
| | | (dry blend) | | | | | | |
| Comp. | Comp. Ex. J | Terpolymer | 3,482 | 4,119 | 316.985 | 0.418 | NA⁽³⁾ | 5.59 |
| Ex. U | | resin⁽²⁾ | | | | (0.295) | | |

Notes for Table V:
⁽¹⁾“SBR” indicates an addition of anti-slip, anti-block and chill roll release additives.
⁽²⁾A terpolymer resin is not an ionomer.
⁽³⁾A “NA” stands for “not applicable” since a terpolymer is not an ionomer.

### Discussion of Results

As shown in Table II, the ARF of Inv. Ex. 2 has good properties and good performance. For example, the Abrasion Resistance Rating (Y) is one of the beneficial performance metrics. The higher the Y, the greater the performance. As described in Table II, the Y for Inv. Ex. 2 is the highest which indicates that Inv. Ex. 2, has the highest abrasion and resistance performance in the presence of oil/grease and seasoning compared to the other Comparative Examples. The other physical properties of the films correlate to Y based on Equation (I). The relationship defined by the linear equation shows the importance of each physical property value to the abrasion resistance rating.

The Abrasion Resistance Rating is an important performance metric for films; and the higher the abrasion resistance rating, the greater the abrasion resistance performance of the film. The Abrasion Resistance Rating is the highest for the ARF of Inv. Ex. 2 which indicates that Inv. Ex. 2 has the highest abrasion and resistance performance in the presence of oil/grease and seasoning compared to the Comparative Examples. The other physical properties of the ARF correlate to the abrasion resistance rating based on Equation (1). The relationship defined by the linear equation, Equation (1), shows the importance of each physical property value to the abrasion resistance rating.

What is claimed is:

1. A composition for fabricating an abrasion resistant film comprising:
(a) at least one ionomer of ethylene (meth)acrylic acid copolymer;
(b) at least one anti-slip additive;
(c) at least one anti-blocking additive;
(d) at least one chill roll release additive; and
(e) optionally, one or more additives different from components (a)-(d);
wherein the at least one ionomer of ethylene (meth)acrylic acid copolymer, component (a), is at least one sodium-based ionomer of ethylene acid copolymer having (i) a neutralized acid content of greater than 7 weight percent, (ii) a free acid content of greater than 9 weight percent, and (iii) a total acid content of greater than 16 weight percent.

2. The composition of claim 1, wherein the at least one anti-slip additive, component (b), is added to the composition as a masterbatch comprising the anti-slip additive and an ethylene-(meth)acrylic acid carrier resin; wherein the at least one anti-blocking additive, component (c), is added to the composition as a masterbatch comprising the anti-blocking additive; and an ethylene-(meth)acrylic acid carrier resin; and wherein the at least one chill roll release additive, component (d), is added to the composition as a masterbatch comprising the chill roll release additive and an ethylene-(meth)acrylic acid carrier resin.

3. The composition of claim 1, wherein the at least one anti-slip additive, component (b), is an oleyl palmitamide additive; wherein the at least one anti-blocking additive, component (c), is a silicon dioxide additive; and wherein the at least one chill roll release additive, component (d), is a behenamide additive.

4. The composition of claim 1, wherein the composition is fabricated into a film member having an abrasion resistance rating value, Y, of greater than 6.0 according to the following Equation (I):
$$Equation ( I )$$
$$Y = 7. 16 - 1.45 ( \frac{A - 3 952.72}{472.23} ) + 4.05 ( \frac{B - 532 \; 5.63}{1257.50} ) + 0.8 \; 50 ( \frac{C - 161.66}{155.33} )$$
wherein Y is an abrasion resistance rating of greater than 6.0; wherein A is an average tensile break stress in the cross direction of the film member; wherein B is an average tensile break stress in the machine direction of the film member; and wherein C is an average normalized Elmendorf tear in the cross direction of the film member.

5. The composition of claim 1, wherein the concentration of the at least one ionomer of acid copolymer, component (a), of the composition is from 20 weight percent to 100 weight percent; wherein the concentration of the at least one anti-slip additive, component (b), of the composition is greater than 0.05 weight percent; wherein the concentration of the at least one anti-blocking additive component (b), of the composition is greater than 0.05 weight percent; and wherein the concentration of the at least one chill roll release additive, component (d), of the composition is greater than 0.05 weight percent.

6. The composition of claim 1, wherein the composition, when fabricated into a film, provides a film exhibiting one or more of the following properties: a tear strength of greater than or equal to 0.4 N/mm in CD; a CD break stress of less than or equal to 48.3 MPa in CD and a MD break stress of greater than or equal to 6.9 MPa in MD using the test method described in ASTM D882; and a static and kinetic coefficient of friction between sealant and metal of less than or equal to 0.35 using the test method described in ASTM D1894.

7. A process for producing a composition for fabricating a film comprising admixing: (a) at least one ionomer of acid copolymer; (b) at least one anti-slip additive; (c) at least one anti-blocking additive; (d) at least one chill roll release additive; and (e) optionally, one or more additives different from components (a)-(d).

8. An abrasion resistant film comprising at least one monolayer film or at least one multilayer film, wherein the at least one monolayer film or the at least one multilayer film includes at least one layer comprising a film fabricated from the film composition of claim 1.

9. The film of claim 8, wherein the film exhibits at least one or more of the following properties: a tear strength of greater than or equal to 0.4 N/mm in CD; a CD break stress of less than or equal to 48.3 MPa in CD and a CD break stress of greater than or equal to 6.9 MPa in MD using the test method described in ASTM D882; and a static and kinetic coefficient of friction between sealant and metal of less than or equal to 0.35 using the test method described in ASTM D1894.

10. A process of manufacturing the film of claim 8, the process comprising the steps of:
(I) admixing (a) at least one ionomer of acid copolymer; (b) at least one anti-slip additive; (c) at least one anti-blocking additive; (d) at least one chill roll release additive; and (e) optionally, one or more additives different from components (a)-(d); and
(II) forming at least one monolayer film or at least one multilayer film from the film admixture of step (I); wherein the at least one monolayer film or the at least one multilayer film includes at least one layer comprising a film fabricated from the film composition of step (I).

11. An article or package comprising an article or package produced from the film of claim 8.

12. The article or package of claim 11, wherein the article or package is a food product package container comprising a multilayered structure, wherein multilayered structure includes at least one layer comprising a film fabricated from the film composition of claim 1; and wherein the film has: (i) sufficient abrasion and scratch resistance properties; and (ii) sufficient resistance to oils and seasoning to avoid environmental stress cracking such that the film liner is capable of contacting an abrasive, seasoned and oily food product without deleteriously affecting the abrasion and scratch resistance properties of the film liner.
